(19) United States
(12) Patent Application Publication
(10) Pub. No.: US 2006/0026273 A1
(43) Pub. Date: Feb. 2, 2006

(54) System and method for detection of reconnaissance activity in networks

(75) Inventors: Oded Comay, Tel Aviv (IL); Doron Shikmoni, Ganei Tikva (IL); Yehezkel Yeshurun, Givataim (IL)

Correspondence Address: DR. MARK FRIEDMAN LTD.;c/o Bill Polkinghorn, 9003 Florin Way, Upper Marlboro, MD, 20772, US

(73) Assignee: FORESCOUT INC.

(21) Appl. No.: 10/902,865

(22) Filed: Aug. 2, 2004

(51) Int. Cl. G06F 15/173

(52) U.S. Cl. 709/223

(57) ABSTRACT

A reconnaissance detector for protecting a network from attack by detecting attempts by one or more inquirers preparing for a network attack to collect information from network resources designated in queries by the inquirers, the reconnaissance detector including: (a) a computer operationally connected to an entry point of the network operative to monitor the queries and responses to the queries from the designated network resources; (b) a network resource data storage operative to store addresses of the designated network resources and respective resource weights of the designated network resources, the resource weights being calculated based on the responses; and (c) an inquirer data storage operative to store addresses of the inquirers and respective inquirer weights, wherein each of the inquirer weights is calculated by accumulating the resource weights designated by each of the inquirers. Preferably, the reconnaissance detector further includes: (d) a mechanism operative to mark the one or more inquirers as attackers when the inquirer weights, associated with the one or more inquirers, are greater than a predetermined threshold.

### FIELD AND BACKGROUND OF THE INVENTION

The present invention relates to a system and method for protecting computer networks from attack by detecting attempts to collect information from network resources prior to and in preparation for a network attack. The present invention addresses the problem of distinguishing between innocent inquirers and potentially malicious inquirers.

The security of computer networks is an increasingly important issue particularly with the growth of wide area networks and the Internet. Owing to an origin in academia, the Internet was developed for efficient transport of data with little concern regarding security. Unauthorized users have relatively easy access to unprotected network resources. Such unauthorized users intrude on privacy, disrupt computer operation and deface Web sites. More serious offenses include theft of proprietary information and damage to computer systems.

Conventional methods for limiting network attacks include firewalls, vulnerability scanners and intrusion detection systems. Firewall techniques involve using a set of rules to compare a header of incoming data packets to specific known attacks. A firewall accepts and denies traffic between three network domains. The first domain is an internal network such as in a corporate environment. Outside the internal network is a second network domain where both the internal network and the outside world have access, sometimes known as a “demilitarized zone” or DMZ. The third domain is the external network of the outside world. Servers accessible to the outside world are put in the DMZ. In the event that a server in the DMZ is compromised, the internal network is still safe.

A network vulnerability scanner operates remotely by examining the network interface on a remote system. The vulnerability scanner looks for vulnerable resources on the remote system and reports on possible vulnerabilities.

Intrusion detection systems (IDS) analyze network traffic. In one algorithm used for a prior art IDS, the number of times a given inquirer is trying to access network resources is counted within a given time interval. An inquirer is classified as an “attacker” if the number exceeds a predetermined threshold. Once an inquirer is classified as an attacker the IDS may use one or more mechanisms to deal with the attacker. One method to deal with an attacker is described in U.S. Pat. No. 6,363,489 entitled “Method for Automatic Intrusion Detection and Deflection in a Network” that discloses providing an unauthorized inquirer with false data. Subsequent detection of the false data is used to mark the unauthorized inquirer. U.S. Pat. No. 6,363,489 is incorporated by reference for all purposes as if fully set forth herein.

None of the aforementioned methods and systems is directed towards distinguishing between innocent inquirers and potentially malicious inquirers by detecting attempts to collect information from network resources prior to and in preparation for a network attack by examining the responses of the network to all inquiries.

There is thus a need for, and it would be highly advantageous to have a system and method for protecting computer networks from attack by detecting attempts to collect information from network resources prior to and in preparation for a network attack and more particularly, by examining the responses of the network to inquiries from all users.

### SUMMARY OF THE INVENTION

According to the present invention there is provided a reconnaissance detector for protecting a network from attack by detecting attempts by one or more inquirers preparing for a network attack to collect information from network resources designated in queries by the inquirers, the reconnaissance detector including: (a) a computer operationally connected to an entry point of the network operative to monitor the queries and responses to the queries from the designated network resources; (b) a network resource data storage operative to store addresses of the designated network resources and respective resource weights of the designated network resources, the resource weights being calculated based on the responses; and (c) an inquirer data storage operative to store addresses of the inquirers and respective inquirer weights, wherein each of the inquirer weights is calculated by accumulating the resource weights designated by each of the inquirers. Preferably, the reconnaissance detector further includes: (d) a mechanism operative to mark the one or more inquirers as attackers when the inquirer weights, associated with the one or more inquirers, are greater than a predetermined threshold.

According to the present invention there is provided a method for protecting a network from attack by detecting attempts by one or more inquirers to collect information from designated network resources as designated in queries by the inquirers, the one or more inquirers preparing for a network attack, the method including the steps of: (a) monitoring the queries, thereby identifying the inquirers and the designated network resources; (b) monitoring responses from the designated network resources to the queries; and (c) storing respectively resource weights of the designated network resources, the resource weights based on the responses. Preferably, the method further includes (d) upon receiving the queries from the inquirers to collect information from the designated network resources, adding respectively a value based on each of the resource weights to each inquirer weight and (e) marking respectively the one or more inquirers as attackers when each inquirer weight associated with the one or more inquirers is greater than a predetermined threshold value. Preferably, the storing of resource weights includes storing of resource weights of zero value to the designated network resources publicly available and storing of resource weights of full value to the designated network resources that do not exist.

According to the present invention there is provided a reconnaissance detector for storing resource weights of designated network resources in a network, the reconnaissance detector including: (a) a computer operationally connected to an entry point of the network operative to monitor queries and responses to the queries from the designated network resources; and (b) a network resource data storage operative for the storing of addresses of the designated network resources and the respective resource weights of the designated network resources, the resource weights being calculated based on the responses.

According to the present invention there is provided a reconnaissance detector for protecting a network from attack by detecting attempts by one or more of inquirers preparing for a network attack, collecting information from designated network resources as designated in queries by the inquirers, the designated network resources having stored resource weights, the reconnaissance detector including: (a) a computer operationally connected to an entry point of the network operative to monitor the queries and responses to the queries from the designated network resources; and (b) an inquirer data storage operative to store addresses of the inquirers and respective inquirer weights, wherein each of the inquirer weights is calculated by accumulating the resource weights designated by the inquirers. Preferably, the reconnaissance detector further includes: (c) a mechanism operative to mark the one or more inquirers as attackers when the inquirer weights are greater than a predetermined threshold.

According to the present invention there is provided a method for protecting a data network from attack by detecting attempts by one or more inquirers preparing for a network attack to collect information from designated network resources as designated in queries by the inquirers, the method comprising the steps of: (a) storing respectively resource weights of the designated network resources; and (b) upon receiving queries from the inquirers to collect information from the designated network resources, adding respectively a value based on each of the resource weights to each inquirer weight.

### BRIEF DESCRIPTION OF THE DRAWINGS

The invention is herein described, by way of example only, with reference to the accompanying drawings, wherein:

FIG. 1 is a simplified block diagram of a network according to an embodiment of the present invention;

FIG. 2 is a simplified block diagram of a network according to another embodiment of the present invention;

FIG. 3 is a is a flow chart of a learning process, according to an embodiment of the present invention;

FIG. 4 is a flow chart of a detection process, according to an embodiment of the present invention.

### DESCRIPTION OF THE PREFERRED EMBODIMENTS

The present invention is of a system and method for protecting computer networks from attack by distinguishing between innocent inquirers and potentially malicious inquirers. Specifically, the present invention can be used to detect attempts to collect information from network resources prior to and in preparation for a network attack and more particularly, by examining the responses of the network to inquiries from all users.

The principles and operation of the present invention may be better understood with reference to the drawings and the accompanying description.

It should be noted, that although the discussion herein relates to local area networks (LAN) and wide area networks (WAN) using an Ethernet 802.3 physical layer with Internet (TCP/IP) protocols, the present invention may, by non-limiting example, be alternatively configured with any type of network, physical layer or protocol.

Before explaining embodiments of the invention in detail, it is to be understood that the invention is not limited in its application to the details of the network and the arrangement of the network components set forth in the following description or illustrated in the drawings. The invention is capable of other embodiments or of being practiced or carried out in various ways. Also, it is to be understood that the phraseology and terminology employed herein is for the purpose of description and should not be regarded as limiting. It should be noted that while the discussion herein is directed to providing security in computer networks, the principles of the present invention may be adapted for use in, and provide benefit for providing security to networks in general, such as telephony networks or cellular networks.

As such, those skilled in the art will appreciate that the conception, upon which this disclosure is based, may readily be utilized as a basis for the designing of other methods and systems for carrying out the several purposes of the present invention. It is important, therefore, that the claims be regarded as including such equivalent constructions insofar as they do not depart from the spirit and scope of the present invention.

By way of introduction, a principal intention of the present invention is to distinguish between innocent inquirers and potentially malicious ones. The method described herein according to an exemplary embodiment of the present invention is understood by analogy to people inside a building with doors. Some of the doors are open, some of them are closed and others are secured in various ways. A person entering an open door does not arouse any undue suspicion. An open door is an entrance to a resource publicly available. However, a person who is found entering closed doors or examining security mechanisms of locked doors is expected to arouse suspicion on the part of security personnel in the building. Consequently security personnel, upon noticing the person entering closed doors, will initiate appropriate measures to prevent the intruder from further activity in the building.

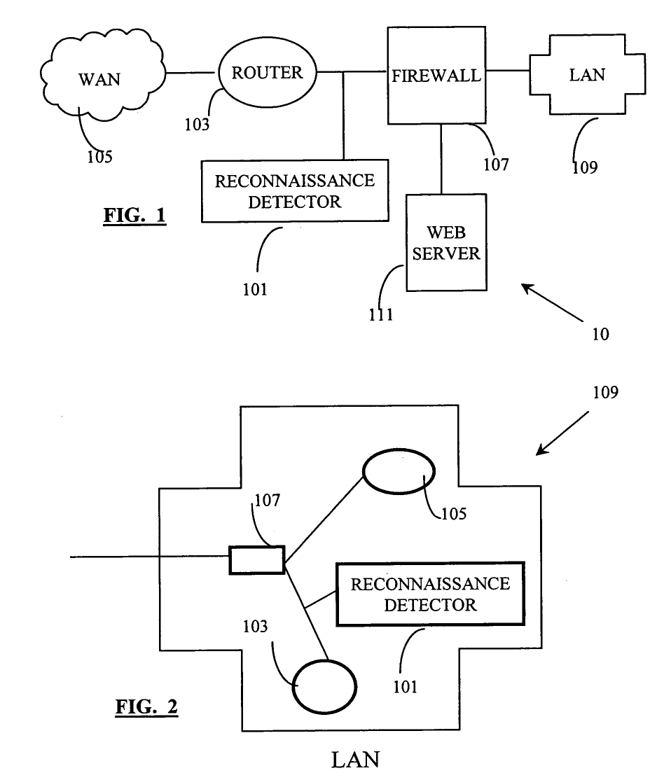

Referring now to the drawings, FIG. 1 illustrates placement of a reconnaissance detector 101, in a computer network 10, according to an embodiment of the present invention. Reconnaissance detector 101 is connected between a router 103, and a firewall 107. Router 103 is preferably a single entry point from wide area network 105 to a firewall 107. Firewall 107 is connected to both a local area network 109 and an Internet server 111. Reconnaissance detector 101 consequently provides security to both local area network 109 and Internet server 111.

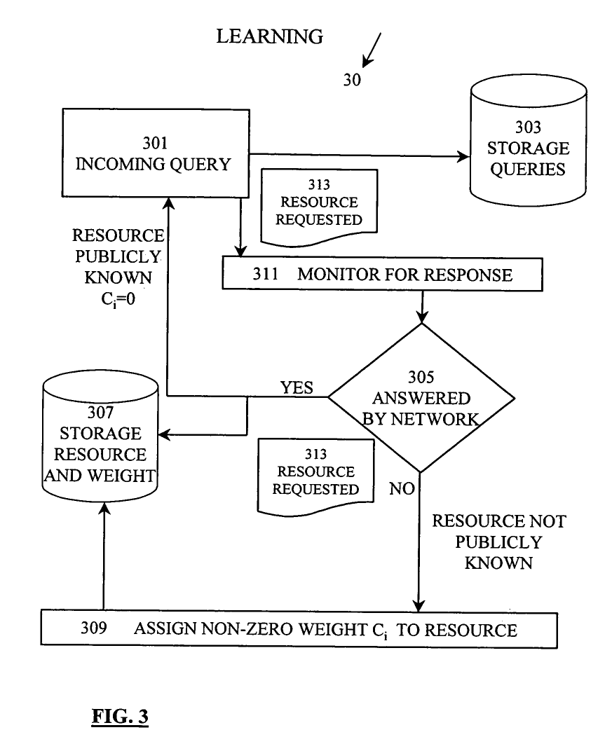

Another possible configuration is shown in FIG. 2 in which reconnaissance detector 101 is situated within local area network 109. Typically, local area networks have sectors that require different levels of security. In local area network 109, sector 105 requires less security than sector 103; for instance confidential information is stored within sector 103 and no such confidential information is stored within sector 105. Therefore, reconnaissance detector 101 is appropriately placed between sector 103 and network element 107, e.g. a physical layer switch, a single access point to sensitive sector 103.

Reconnaissance detector 101 is typically a computer including a processor, memory, data storage and a network interface operationally attached in the usual way. The term “computer” as defined herein includes a processor, memory, data storage and a network interface.

In one embodiment of the present invention that provides for local management, reconnaissance detector 101 further includes equipment for human interface such as a display, a keyboard and a mouse. In another embodiment of the present invention, management of reconnaissance detector 101 is provided remotely through network 10 and/or network 109 and equipment for the human interface is not required.

Reconnaissance detector 101 and network interface are configured to operate in a “sniffer” mode, or in the way of the data traffic (“inline”). In computer network 10, for instance, all communications traffic between router 103 and firewall 107 is monitored in both directions. In a packet switched network, such as Ethernet, all packets in both directions are copied and opened and, if necessary, the copies are temporarily stored and subsequently opened.

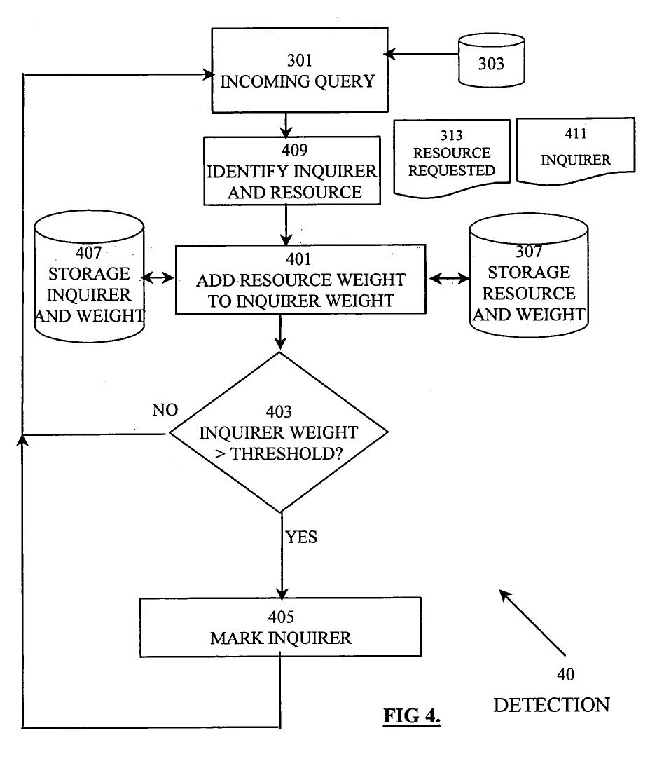

Reconnaissance detector 101 during operation runs two simultaneous processes, a learning process 30 as shown in a flow diagram of FIG. 3 and a detection process 40 as shown in a flow diagram of FIG. 4. Referring to FIG. 3, an incoming query 301 originates from an inquirer 411 in network 10. Query 301 is optionally stored in query storage 303. Reconnaissance detector 101 monitors traffic (step 311) for a response to query 301. If query 301 receives a response (decision block 305) then designated resource 313 is publicly known and a resource weight 413 cᵢ=0 is assigned to resource 313 designated by query 301. Otherwise, if a network response is not received (decision block 305) then resource 313 designated by query 301 is not publicly available and a non-zero resource weight 413 is assigned to resource 313 designated by query 301. Similarly, if designated resource 313 does not exist, a full weight, e.g. cᵢ=1, is assigned to resource 313 by query 301. Resources 313 and respective weights 413 are stored in resource storage 307.

Optionally, resource weights are assigned and stored in resource storage 307 prior to learning process 30 based on known confidentiality levels of resources 313. The term “resources” of the network are entities involved in network communications including computers, ports, services, applications and/or user names. The term “address” referring to a network resource as used herein refers to any identifier or combination of identifiers for a network resource.

FIG. 4 illustrates a detection process 40, according to an embodiment of the present invention. Detection process 40 begins by reading an incoming query 301 and identifying (step 409) an inquirer 411 and a designated resource 313 by incoming query 301. Inquirer 411 is identified by an identifier such as a name, a password, and/or an address such as an IP address. The term “address” referring to an inquirer as used herein refers to any identifier or combination of identifiers for an inquirer.

A resource weight 413 of requested resource 313 is retrieved from data storage 307, previously stored as part of learning process 30. Resource weight 413 is added (step 401) to an inquirer weight 415 and resulting inquirer weight 415 is stored along with inquirer 411 in data storage 407 of inquirers 411 and respective inquirer weights 415. Each time inquirer 411 designates a resource 313, inquirer weight 415 is accumulated by, for instance by adding resource weight 413 to accumulated inquirer weight 415. The term “accumulate” as defined herein refers to an iterative process of adding a first parameter A or a function of first parameters to a second parameter B, e.g. B=B+A. If inquirer weight 415 increases above a predetermined threshold value (decision block 403), then inquirer 411 is marked as an attacker.

With respect to the above description, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

While the invention has been described with respect to a limited number of embodiments, it will be appreciated that many variations, modifications and other applications of the invention may be made.

What is claimed is:

1. A reconnaissance detector for protecting a network from attack by detecting attempts by at least one of a plurality of inquirers collecting information from designated network resources as designated in queries by the inquirers, the at least one inquirer preparing for a network attack, the reconnaissance detector comprising:
(a) a computer operationally connected to an entry point of the network operative to monitor the queries and responses to the queries from the designated network resources;
(b) a network resource data storage operative to store addresses of the designated network resources and respective resource weights of the designated network resources, said resource weights being calculated based on said responses; and
(c) an inquirer data storage operative to store addresses of the inquirers and respective inquirer weights, wherein each of said inquirer weights is calculated by accumulating said resource weights designated by said each of the inquirers.

2. The reconnaissance detector, according to claim 1, further comprising:
(d) a mechanism operative to mark the at least one inquirer as an attacker when said each of said inquirer weights, associated with the at least one inquirer, is greater than a predetermined threshold.

3. A method for protecting a network from attack by detecting attempts by at least one of a plurality of inquirers collecting information from designated network resources as designated in queries by the inquirers, the at least one inquirer preparing for a network attack, the method comprising the steps of:
(a) monitoring the queries, thereby identifying the inquirers and the designated network resources;
(b) monitoring responses from the designated network resources to the queries; and
(c) storing respectively resource weights of the designated network resources, said resource weights based on said responses.

4. The method, according to claim 3, further comprising the step of:
(d) upon receiving the queries from the inquirers to collect information from the designated network resources, adding respectively a value based on each of said resource weights to each inquirer weight.

5. The method, according to claim 4, further comprising the step of:
(e) marking respectively the at least one inquirer as an attacker when said each inquirer weight associated with the at least one inquirer is greater than a predetermined threshold value.

6. The method, according to claim 3, wherein said storing resource weights includes storing of resource weights of zero value for the designated network resources publicly available.

7. The method, according to claim 3, wherein said storing resource weights includes storing of resource weights of full value for the designated network resources that do not exist.

8. A reconnaissance detector for storing resource weights of designated network resources in a network, the reconnaissance detector comprising:
(a) a computer operationally connected to an entry point of the network operative to monitor queries and responses to said queries from the designated network resources; and
(b) a network resource data storage operative for the storing of addresses of the designated network resources and the respective resource weights of the designated network resources, the resource weights being calculated based on said responses.

9. A reconnaissance detector for protecting a network from attack by detecting attempts by at least one of a plurality of inquirers collecting information from designated network resources as designated in queries by the inquirers, the designated network resources having stored resource weights, the at least one inquirer preparing for a network attack, the reconnaissance detector comprising:
(a) a computer operationally connected to an entry point of the network operative to monitor the queries and responses to the queries from the designated network resources; and
(b) an inquirer data storage operative to store addresses of the inquirers and respective inquirer weights, wherein each of said inquirer weights is calculated by accumulating the resource weights designated by said each of the inquirers.

10. The reconnaissance detector, according to claim 9, further comprising:
(c) a mechanism operative to mark the at least one inquirer as an attacker when said each of said inquirer weights, associated with the at least one inquirer, is greater than a predetermined threshold.

11. A method for protecting a data network from attack by detecting attempts by at least one of a plurality of inquirers collecting information from designated network resources as designated in queries by the inquirers, the at least one inquirer preparing for a network attack, the method comprising the steps of:
(a) storing respectively resource weights of the designated network resources; and
(b) upon receiving queries from said inquirers to collect information from the designated network resources, adding respectively a value based on each of said resource weights to each inquirer weight.
